(19) United States
(12) Patent Application Publication
(10) Pub. No.: US 2012/0313046 A1
(43) Pub. Date: Dec. 13, 2012

(54) METHOD OF CAPTURING ACID COMOUNDS THROUGH HYDRATE FORMATION WITH A DEMIXING STAGE

(76) Inventors: Anne SINQUIN, (US); Alexandre Scondo, (US)

(21) Appl. No.: 13/488,740

(22) Filed: Jun. 5, 2012

(30) Foreign Application Priority Data
Jun. 10, 2011 (FR) 11/01791

(51) Int. Cl. B01D 53/00; C10J 3/72; C01B 3/32; B01D 53/62; B01D 53/52

(52) U.S. Cl. 252/372; 423/210; 423/220; 48/127.3; 48/128

(57) ABSTRACT

A method of capturing acid compounds contained in a gas, wherein the following stages are carried out:
a) contacting (R1) gas (2) with a liquid solution (9) comprising a mixture of an aqueous phase and of a non-water miscible phase so as to produce a solution (3) comprising acid compound hydrates and an acid compound depleted gas (10),
b) dividing (B1) the solution comprising acid compound hydrates into a hydrate-rich fraction and a fraction rich in non-water miscible phase,
c) separating (B1) hydrate-rich fraction (4) from fraction (5) rich in non-water miscible phase,
d) heating (R2) the hydrate-rich fraction so as to release gaseous acid compounds (6) by dissociating the hydrates and to produce a water-rich fraction (8),
e) mixing (B2) the fraction rich in non-water miscible phase obtained in stage c) with the water-rich fraction produced in stage d) so as to produce the liquid solution used in stage a).

### FIELD OF THE INVENTION

The present invention relates to the sphere of capture of acid compounds such as the carbon dioxide (CO₂) or the hydrogen sulfide (H₂S) contained in a gas.

### BACKGROUND OF THE INVENTION

Gas hydrates are solid crystals that form when gas molecules are in the presence of water under certain pressure and temperature conditions. The water molecules form dodecahedral cages that trap CO₂, H₂S, methane or ethane molecules and allow large amounts of such molecules to be stored. In general, gas hydrates form naturally at low temperature and at high pressure, of the order of 16 bars at 0° C. for a gas containing 100% CO₂ and of the order of 72 bars at 0° C. for a gas containing 16% CO₂.

Document WO-2008/142,262 describes a method of enrichment in acid gas contained in a gas, wherein a feed gas is contacted with a mixture of at least two liquid phases non-miscible, with one another, including an aqueous phase, so as to form hydrates. The hydrate slurry is then sent to a dissociation drum where the hydrates are dissociated through heating. The gas from the dissociation drum is enriched in acid compounds in relation to the feed gas.

The present invention aims to improve the energy efficiency of the method described in document WO-2008/142,262 by separating the hydrate slurry into two fractions and by sending only the hydrate-enriched fraction to the hydrate dissociation stage in order to reduce the amount of heat required for the hydrate slurry to reach the hydrate dissociation temperature.

### SUMMARY OF THE INVENTION

In general terms, the invention describes a method of capturing acid compounds contained in a gas, wherein the following stages are carried out:
a) contacting the gas with a liquid solution comprising a mixture of an aqueous phase and of a non-water miscible phase so as to produce a solution comprising acid compound hydrates and an acid compound depleted gas,
b) dividing the solution comprising acid compound hydrates into a hydrate-rich fraction and a fraction rich in non-water miscible phase,
c) separating the hydrate-rich fraction from the fraction rich in non-water miscible phase,
d) heating the hydrate-rich fraction so as to release gaseous acid compounds by dissociating the hydrates and to produce a water-rich fraction,
e) mixing the fraction rich in non-water miscible phase obtained in stage c) with the water-rich fraction produced in stage d) so as to produce the liquid solution used in stage a).

According to the invention, stages b) and c) can be carried out in a separation device and stage d) is carried out in a reactor.

Alternatively, stages b), c) and d) can be carried out successively in the same device.

The method according to the invention can be implemented with the following operating conditions:

stage a) is carried out at a pressure ranging between 0.1 and 20 bars, and at a temperature ranging between −5° C. and 20° C.,

stages b) and c) are carried out at a pressure ranging between 0.1 and 20 bars,

stage d) is carried out at a pressure ranging between 5 and 70 bars, and at a temperature ranging between −5° C. and 30° C.,

stage e) is carried out at a pressure ranging between 0.1 and 20 bars.

Alternatively, the method according to the invention can be implemented with the following operating conditions:
stage a) is carried out at a pressure ranging between 0.1 and 20 bars, and at a temperature ranging between −5° C. and 20° C.,

stages b) and c) are carried out at a pressure ranging between 5 and 70 bars,

stage d) is carried out at a pressure ranging between 5 and 70 bars, and at a temperature ranging between −5° C. and 30° C.,

stage e) is carried out at a pressure ranging between 0.1 and 20 bars.

According to the invention, prior to stage a), a stage of cooling the liquid solution can be carried out.

The non-water miscible phase can be selected from among the group made up of: hydrocarbon solvents, silicone type solvents, halogenated or perhalogenated solvents, and mixtures thereof.

The liquid solution can furthermore comprise at least one non-ionic, anionic, cationic or zwitterionic amphiphilic compound having at least the anti-agglomeration property of hydrates.

The liquid solution can also comprise at least one hydrate promoter compound selected from among tetrahydrofurane and the compounds of general formula (I):

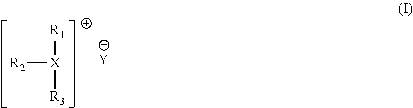

with X═S, N—R₄ or P—R₄,
Y is an anion selected from the group consisting of a hydroxyl, a sulfate or a halogen,
R₁, R₂, R₃, R₄ are identical or different, and selected from the group consisting of linear or branched C1-C5 alkyl radicals.

Preferably, the liquid solution can comprise tetrahydrofurane and a hydrate promoter compound of general formula (I).

The gas can be a combustion fume and the acid compounds can contain CO₂.

Alternatively, the gas can be selected from among a natural gas, a Claus tail gas, a syngas, a conversion gas, a biomass fermentation gas, and the acid compounds can comprise at least one of the following elements: CO₂ and H₂S.

### BRIEF DESCRIPTION OF THE FIGURES

Other features and advantages of the invention will be clear from reading the description hereafter, with reference to the accompanying figures wherein:

FIG. 1 describes a preferred embodiment of the method according to the invention,

FIGS. 2 and 3 describe two other embodiments of the method according to the invention.

### DETAILED DESCRIPTION

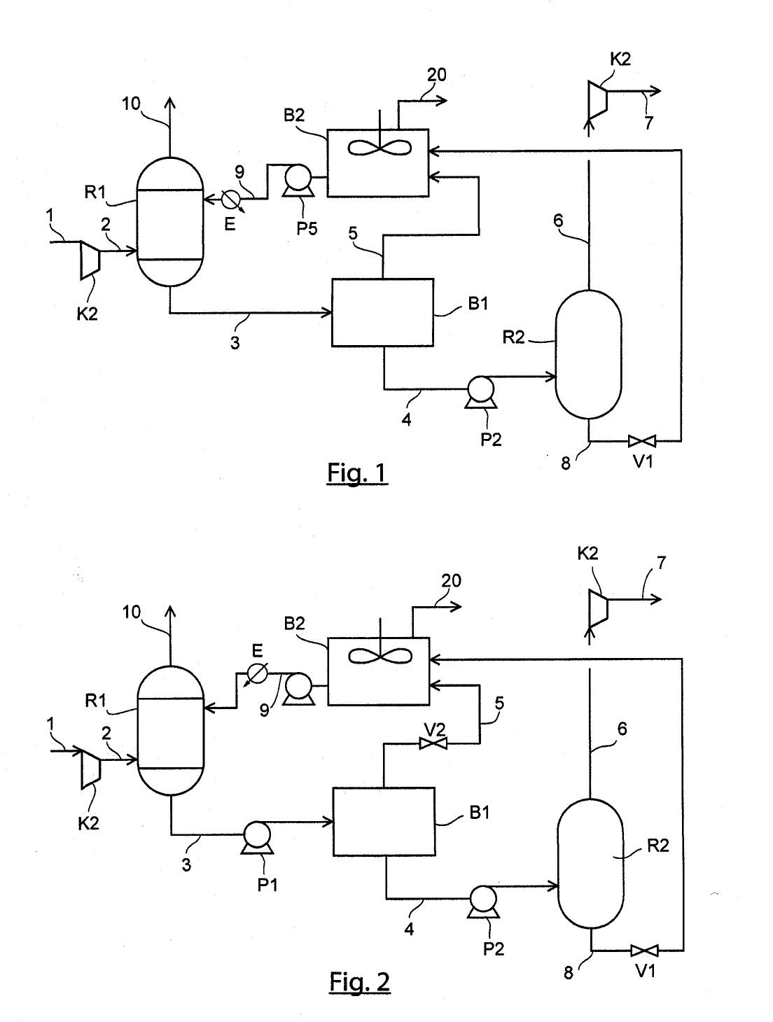

The deacidizing method according to the invention can be applied to various gaseous feeds. In FIG. 1, the gaseous feed flows in through line 1. For example, the method allows to decarbonate combustion fumes, to remove acid compounds from a natural gas or a Claus tail gas. The method also allows to remove the acid compounds contained in syngases, conversion gases, gases from integrated coal or natural gas combustion plants, and biomass fermentation gases. “Acid compounds” are understood to be CO₂ and/or H₂S in the sense of the present invention.

Preferably, the invention can be applied to the capture of the CO₂ contained in combustion fumes. In this case, the gas to be treated flowing in through line 1 is a combustion fume comprising CO₂, for example in a proportion ranging between 5% and 30% by volume. The combustion fumes can be produced by a thermal plant for electricity production. The capture method according to the invention can also be applied to all the combustion fumes produced for example in a refinery, in a cement plant, in an iron and steel plant.

Combustion fumes contain nitrogen and CO₂, oxygen and water vapour, as well as NOx and SOx as traces. The volume concentration of CO₂ is typically in the 3-15% range, the volume concentration of H₂O can be in the 1-15% range, and the cumulative volume concentration of nitrogen and oxygen can be between 50 and 95%. The pressure of the combustion fumes can be close to the atmospheric pressure and at a temperature ranging between 100° C. and 250° C.

The combustion fumes produced by a blast furnace are richer in CO₂, in a proportion generally ranging between 20% and 30% by volume, and at a higher pressure generally ranging between 2 and 4 bara. These fumes can also contain CO in proportions ranging between 15% and 50% by volume.

In reference to FIG. 1, the gas flowing in through line 1 is optionally compressed by compressor K2, then fed into contactor R1 through line 2. In contactor R1, the gas is contacted with a liquid solution flowing in through line 9. The liquid solution comprises a mixture of at least two non-miscible liquid phases, one consisting of water. The liquid solution can furthermore comprise an amphiphilic compound. The composition of the liquid solution is described in detail hereafter. In R1, the gas and the liquid solution are contacted under pressure and temperature conditions compatible with the formation of acid compound hydrates, i.e. acid compound molecules trapped in cages consisting of water molecules. When applying the method to a combustion fume, CO₂ hydrates are formed. For example, contacting the gas with the liquid solution is carried out in R1 at a temperature ranging between −5° C. and 20° C., preferably between −5° C. and 15° C., or even between 0° C. and 10° C., and at a pressure ranging between 0.1 and 20 bars, preferably between 1 and 20 bars, or even between 1 and 10 bars. In the present description, the pressures are expressed in absolute values. Hydrate formation can be favoured by adding hydrate promoter compounds to the liquid solution. The acid compound hydrate particles are dispersed in the non-water miscible liquid phase and carried in form of a solid suspension in this phase. In R1, the gas that is not converted to hydrates is depleted in acid compounds. It is discharged from R1 through line 10.

The hydrate slurry formed by the hydrates dispersed in the non-water miscible phase is discharged from contactor R1 through line 3 and fed into separating device B1. The pressure in B1 can range between 0.1 and 20 bars, preferably between 1 and 20 bars. Furthermore, the pressure can be approximately equal to the pressure in R1. Preferably, the pressure in B1 is kept at a lower value than the pressure in R1 so as to ensure that the hydrate slurry flows from R1 to B1. For example, the pressure in B1 is equal to the pressure in R1 reduced by a value of 0.1 to 2 bars. Alternatively to the pressure decrease in B1 in relation to the pressure in R1, or in addition to the pressure decrease in B1 in relation to the pressure in R1, it is possible to use a pump installed on line 3 to ensure the flow of the hydrate slurry from R1 into B1. Preferably, the slurry is kept in B1 at a lower temperature than the hydrate dissociation temperature, considering the pressure prevailing in B1. For example, the temperature ranges between −5° C. and 20° C.

In device B1, the hydrate slurry is divided into two fractions: a hydrate-enriched fraction poor in non-water miscible liquid and a hydrate-poor fraction enriched in non-water miscible liquid. Division of the slurry can be carried out using any technique suited to the separation of a solid and of a liquid, notably through decantation, filtration, centrifugation, creaming. The decantation and creaming techniques are preferably used in order to limit the energy consumption of the method according to the invention. The two fractions are then separated and sent to reactor R2 and mixing device B2 respectively. In fact, the hydrate-enriched fraction poor in non-water miscible liquid is sent through line 4 and pump P2 to reactor R2 to carry out hydrate dissociation. The hydrate-poor fraction enriched in non-water miscible liquid is sent through line 5 to mixing device B2. The flow of the hydrate-poor fraction enriched in non-water miscible liquid from B1 to B2 can be provided by a pressure difference between B1 and B2 and/or by using a pump on line 5.

Pump P2 allows the hydrate-enriched fraction to be sent from B1 to R2 and furthermore the pressure of this fraction to be raised to a value ranging between 5 and 70 bars, preferably between 30 and 70 bars. In R2, the hydrate-enriched fraction under pressure between 5 and 70 bars, preferably between 30 and 70 bars, is heated to cause dissociation of the hydrates by releasing CO₂ in gas form and a liquid aqueous phase. The hydrate-enriched fraction can be heated up to a temperature ranging between −5° C. and 30° C., preferably between 15° C. and 30° C., or even between 20° C. and 30° C. Preferably, the pressure and temperature conditions in reactor R2 are below the CO₂ dew-point pressure and temperature conditions so as to avoid liquid CO₂ formation in R2. For example, heating is performed using a heating resistor that directly heats the hydrate-enriched fraction or the walls of reactor R2. Heating in R2 can also be achieved by a heat exchanger with a heat carrier. The hydrate-enriched fraction can also be heated in line 4 supplying R2 in order to improve the efficiency of the method and to reserve R2 for separation between the gas and the liquid. The gaseous CO₂ is discharged from R2 through line 6. It can be compressed by compressor K2 and discharged through line 7 in order to be stored or sequestered in a reservoir. The liquid effluent remaining in R2 essentially consists of water. This liquid is discharged from R2 through line 8 and expanded in expansion device V1, a valve or a turbine for example, prior to being fed into mixing device B2. Expansion is carried out up to a pressure close to the pressure of reactor R1, for example a pressure ranging between 1 and 20 bars. A flash drum arranged on line 8 can be used to separate the CO₂ released in gas form upon expansion.

Mixing device B2 allows the hydrate-poor fraction enriched in non-water miscible liquid coming from B1 through line 5 to be mixed with the liquid effluent coming from R2 through line 8. For example, device B2 is an enclosure provided with a rotary blade mixer. Device B2 can also comprise restrictions at the inlets of lines 5 and 8 that allow the fluids flowing in through these two lines to be sent in a cocurrent direction so as to be mixed together. B2 can comprise a discharge line 20 for a gas, CO₂ for example, that could possibly be released in B2. The pressure in B2 can be at a value close to the pressure in reactor R1, for example a pressure ranging between 0.1 and 20 bars, preferably between 1 and 20 bars. The mixture obtained in B2 is pumped by pump P5, cooled in exchanger E to the operating temperature of R1, for example to a temperature ranging between −10° C. and 20° C., preferably between −5° C. and 10° C., and fed into contactor R1 through line 9 at the operating pressure of R1.

The method schematized in FIG. 1 can be implemented using several separating devices B1 operating in parallel, and optionally storage capacities allowing to store amounts of fractions obtained at the outlet of device B1, so as to allow continuous operation of the process.

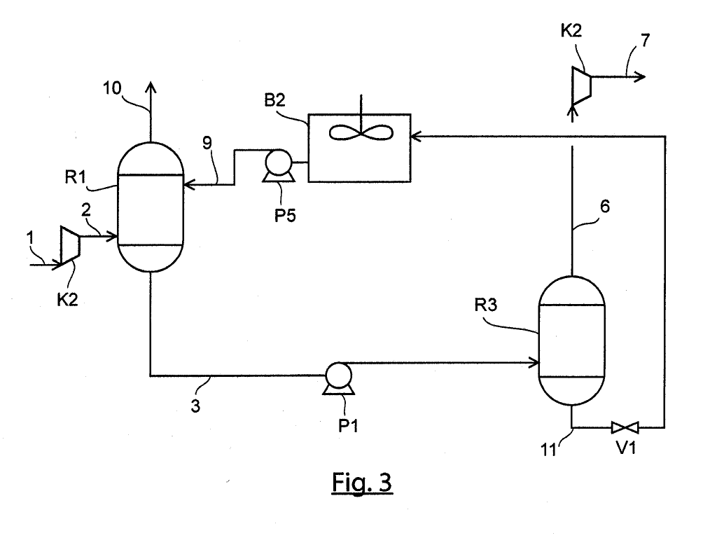

FIG. 2 shows a variant of the method described in reference to FIG. 1 where separation of the hydrate slurry is carried out at high pressure. The reference numbers of FIG. 2 identical to those of FIG. 1 designate the same elements.

In reference to FIG. 2, the gas flowing in through line 1, optionally compressed by compressor K2, is fed into contactor R1 through line 2. In contactor R1, the gas is contacted with the liquid solution flowing in through line 9.

For example, contacting the gas with the liquid solution is carried out in R1 at a temperature ranging between −5° C. and 20° C., preferably between −5° C. and 15° C., or even between 0° C. and 10° C., and at a pressure ranging between 0.1 and 20 bars, preferably between 1 and 20 bars, or even between 1 and 10 bars.

The gas that is not converted to hydrates in R1 is depleted in acid compounds and it is discharged from R1 through line 10. The hydrate slurry formed by the hydrates dispersed in the non-water miscible phase is discharged from contactor R1 through line 3 and pumped by pump P1 so as to be fed into separating device B1.

Pump P1 allows the pressure of the hydrate slurry to be raised to a value ranging between 5 and 70 bars, preferably between 30 and 70 bars.

In device B1, the hydrate slurry is divided into two fractions: a hydrate-enriched fraction poor in non-water miscible liquid and a hydrate-poor fraction enriched in non-water miscible liquid. In the method schematized in FIG. 2, B1 can operate at a pressure ranging between 5 and 70 bars, preferably between 30 and 70 bars, and at a temperature below the hydrate dissociation temperature, considering the pressure prevailing in B1. The hydrate-enriched fraction poor in non-water miscible liquid is sent through line 4 and optionally pump P2 to reactor R2 to carry out hydrate dissociation. The hydrate-poor fraction enriched in non-water miscible liquid is expanded by expansion device V2, a valve or a turbine for example, and sent through line 5 to mixing device B2. V2 allows to carry out expansion up to a pressure close to the operating pressure of R1, for example a pressure ranging between 0.1 and 20 bars, preferably between 1 and 20 bars. A flash drum arranged on line 5 can be used to separate the CO₂ released in gas form upon expansion.

In R2, the hydrate-enriched fraction is heated to cause dissociation of the hydrates by releasing CO₂ in gas form and an aqueous phase. The pressure in R2 can range between 5 and 70 bars, preferably between 30 and 70 bars. The hydrate-enriched fraction can be heated up to a temperature ranging between −5° C. and 30° C., preferably between 15° C. and 30° C., or even between 20° C. and 30° C. The gaseous CO₂ is discharged from R2 through line 6. It can be compressed by compressor K2 and discharged through line 7 in order to be stored or sequestered in a reservoir. The liquid effluent remaining in R2 is discharged through line 8 and expanded in expansion device V1 prior to being fed into mixing device B2. Expansion is carried out up to a pressure close to the pressure of reactor R1, for example a pressure ranging between 0.1 and 20 bars, preferably between 1 and 20 bars. A flash drum arranged on line 8 can be used to separate the CO₂ released in gas form upon expansion.

Mixing device B2 allows the hydrate-poor fraction enriched in non-water miscible liquid coming from B1 through line 5 to be mixed with the liquid effluent coming from R2 through line 8. B2 can comprise a discharge line 20 for a gas, CO₂ for example, that could possibly be released in B2. The pressure in B2 can be at a value close to the pressure in reactor R1, for example a pressure ranging between 0.1 and 20 bars, preferably between 1 and 20 bars. The mixture obtained in B2 is pumped by pump P5, cooled in exchanger E to the operating temperature of R1, for example to a temperature ranging between −10° C. and 20° C., preferably between −5° C. and 10° C., and fed into contactor R1 through line 9 at the operating pressure of R1.

FIG. 3 represents a variant of the method described in reference to FIG. 2 where separation of the hydrate slurry into two fractions and dissociation of the hydrates is carried out in the same device. The reference numbers of FIG. 3 identical to those of FIG. 2 designate the same elements.

In reference to FIG. 3, the gas flowing in through line 1, optionally compressed by compressor K2, is fed into contactor R1 through line 2. In contactor R1, the gas is contacted with the liquid solution flowing in through line 9.

For example, contacting the gas with the liquid solution is carried out in R1 at a temperature ranging between −5° C. and 20° C., preferably between −5° C. and 15° C., or even between 0° C. and 10° C., and at a pressure ranging between 0.1 and 20 bars, preferably between 1 and 20 bars, or even between 1 and 10 bars.

The gas that is not converted to hydrates in R1 is depleted in acid compounds and it is discharged from R1 through line 10. The hydrate slurry formed by the hydrates dispersed in the non-water miscible phase is discharged from contactor R1 through line 3 and pumped by pump P1 so as to be fed into device R3.

Pump P1 allows the pressure of the hydrate slurry to be raised to a value ranging between 5 and 70 bars, preferably between 30 and 70 bars.

According to the invention, in device R3, the stages of slurry division into two fractions, of separation of the two fractions and of hydrate dissociation are carried out successively. First, the hydrate slurry is divided into two fractions in device R3: a hydrate-enriched fraction poor in non-water miscible liquid and a hydrate-poor fraction enriched in non-water miscible liquid. The same separation techniques as those described for device B1 in FIG. 1 can be used. Then, the two fractions are separated by discharging from R3 the fraction enriched in non-water miscible liquid through line 11 and expansion device V1 prior to feeding it into mixing device B2. The hydrate-enriched fraction poor in non-water miscible liquid remains in device R3. Thirdly, the hydrate-enriched fraction is heated in device R3 up to a temperature ranging between −5° C. and 30° C., preferably between 15° C. and 30° C., or even between 20° C. and 30° C., so as to cause dissociation of the hydrates by releasing acid compounds in gas form and an aqueous phase. The hydrate separation and dissociation stages can be carried out in R3 between 5 and 70 bars, preferably between 30 and 70 bars. The gaseous acid compounds are discharged from R3 through line 6. They can be compressed by compressor K2 and discharged through line 7 to be stored or sequestered in a reservoir. The liquid effluent remaining in R3 is discharged from R3 through line 11 and expansion device V1 prior to being fed into mixing device B2 that already contains the fraction enriched in non-water miscible liquid. The method schematized in FIG. 3 can be used with several devices R3 operating in parallel, and optionally storage capacities allowing to store amounts of fractions obtained at the outlet of devices R3, thus allowing continuous operation of the process.

In mixing device B2, the hydrate-poor fraction enriched in non-water miscible liquid is mixed with the liquid effluent. The pressure in B2 can be at a value close to the pressure in reactor R1, for example a pressure ranging between 0.1 and 20 bars, preferably between 1 and 20 bars. The mixture obtained in B2 is pumped by pump P5, cooled in exchanger E up to the operating temperature of R1, for example a temperature ranging between −10° C. and 20° C., preferably between −5° C. and 10° C., and fed into contactor R1 through line 9.

The liquid solution used in the method according to the invention consists of a mixture of water and of a phase, also referred to as solvent, which is not water miscible. At least one amphiphilic compound having the property of stabilizing the water/non-water miscible solvent mixture in emulsion form can be added to this mixture. Hydrate promoters can also be added to the liquid solution.

The solvent contained in the liquid solution used in the method according to the invention can be selected from among several families: hydrocarbon solvents, silicone type solvents, halogenated or perhalogenated solvents.

In the case of hydrocarbon solvents, the solvent can be selected from the group consisting of:

rapeseed methyl esters,

aliphatic cuts, for example isoparaffinic cuts having a sufficiently high flash point to be compatible with the method according to the invention,

organic solvents of aromatic cut or naphthenic cut type can also be used with the same flash point conditions,

pure products or mixtures selected from among the branched alkanes, cycloalkanes and alkylcycloalkanes, aromatic compounds, alkylaromatics.

The hydrocarbon solvent used in the method according to the invention is characterized in that its flash point is above 40° C., preferably above 75° C. and more precisely above 100° C. Its crystallization point is below −5° C.

The solvents of silicone type, alone or in admixture, are for example selected from the group consisting of:

linear polydimethylsiloxanes (PDMS) of (CH₃)₃—SiO—[(CH₃)₂—SiO]ₙ—Si(CH₃)₃ type with n ranging between 1 and 900, corresponding to viscosities at ambient temperature ranging between 0.1 and 10,000 mPa·s,

polydiethylsiloxanes having a viscosity at ambient temperature ranging between 0.1 and 10,000 mPa·s,

cyclic polydimethylsiloxanes D₄ to D₁₀, preferably D₅ to D₈. Unit D represents the monomer unit dimethylsiloxane,

poly(trifluoropropyl methyl siloxanes).

The halogenated or perhalogenated solvents used in the method are selected from among perfluorocarbides (PFC), hydrofluoroethers (HFE), perfluoropolyethers (PFPE).

The halogenated or perhalogenated solvent used for implementing the method according to the invention is characterized in that its boiling point is greater than or equal to 70° C. at atmospheric pressure and its viscosity is below 1 Pa·s at ambient temperature and atmospheric pressure.

The water/solvent proportions of the liquid solution can respectively range between 0.5/99.5 and 60/40 vol. %, preferably between 10/90 and 50/50 vol. %, and more precisely between 20/80 and 35/65 vol. % in relation to the total volume of the composition.

The amphiphilic compounds that can go into the liquid solution used for implementing the method according to the invention are chemical compounds (monomer or polymer) having at least one hydrophilic or polar chemical group, with a high affinity with the aqueous phase and at least one chemical group having a high affinity with the solvent (commonly referred to as hydrophobic). They have the property of stabilizing the water/non-water miscible solvent mixture, optionally in emulsion form, and of dispersing the hydrate particles in the non-water miscible phase.

The amphiphilic compounds comprise a hydrophilic part that can be either neutral or anionic, or cationic, or zwitterionic. The part having a high affinity with the solvent (referred to as hydrophobic) can be hydrocarbon-containing, silicone-containing or fluoro-silicone-containing, or halogenated or perhalogenated.

The hydrocarbon-containing amphiphilic compounds used alone or in admixture are selected from the group consisting of the non-ionic, anionic, cationic or zwitterionic amphiphilic compounds.

The non-ionic compounds are characterized in that they contain:

a hydrophilic part comprising either alkylene oxide groups, hydroxy groups or amino alkylene groups,

a hydrophobic part comprising a hydrocarbon chain derived from an alcohol, a fatty acid, an alkylated derivative of a phenol or a polyolefin, for example derived from isobutene or butene.

The bond between the hydrophilic part and the hydrophobic part can be, for example, an ether, ester or amide function. This bond can also be obtained by a nitrogen or sulfur atom. Examples of non-ionic amphiphilic hydrocarbon-containing compounds are oxyethylated fatty alcohols, alkoxylated alkylphenols, oxyethylated and/or oxypropylated derivatives, sugar ethers, polyol esters, such as glycerol, polyethylene glycol, sorbitol and sorbitan, mono and diethanol amides, carboxylic acid amides, sulfonic acids or amino acids.

The anionic amphiphilic hydrocarbon-containing compounds are characterized in that they contain one or more functional groups ionizable in the aqueous phase so as to form negatively charged ions. These anionic groups provide the surface activity of the molecule. Such a functional group is an acid group ionized by a metal or an amine. The acid can be, for example, carboxylic, sulfonic, sulfuric or phosphoric acid. The following anionic amphiphilic hydrocarbon-containing compounds can be mentioned:

carboxylates such as metallic soaps, alkaline soaps or organic soaps (such as N-acyl amino acids, N-acyl sarcosinates, N-acyl glutamates and N-acyl polypeptides),

sulfonates such as alkylbenzenesulfonates (i.e. alkoxylated alkylbenzenesulfonates), paraffin and olefin sulfonates, ligosulfonates or sulfonsuccinic derivatives (such as sulfosuccinates, hemisulfosuccinates, dialkylsulfosuccinates, for example sodium dioctyl-sulfosuccinate),

sulfates such as alkylsulfates, alkylethersulfates and phosphates.

The cationic amphiphilic hydrocarbon-containing compounds are characterized in that they contain one or more functional groups ionizable in the aqueous phase so as to form positively charged ions. Examples of cationic hydrocarbon-containing compounds are:

alkylamine salts selected from the group consisting of alkylamine ethers, alkyl dimethyl benzyl ammonium derivatives and alkoxylated alkyl amine derivatives,

heterocyclic derivatives such as pyridinium, imidazolium, quinolinium, piperidinium or morpholinium derivatives.

The zwitterionic hydrocarbon-containing compounds are characterized in that they have at least two ionizable groups, such that at least one is positively charged and at least one is negatively charged. The groups are selected from among the anionic and cationic groups described above, such as for example betaines, alkyl amido betaine derivatives, sulfobetaines, phosphobetaines or carboxybetaines.

The amphiphilic compounds comprising a neutral, anionic, cationic or zwitterionic hydrophilic part can also have a silicone or fluoro-silicone hydrophobic part (defined as having a high affinity with the non-water miscible solvent). These silicone amphiphilic compounds, oligomers or polymers, can also be used for water/organic solvent mixtures, water/halogenated or perhalogenated solvent mixtures or water/silicone solvent mixtures.

The neutral silicone amphiphilic compounds can be oligomers or copolymers of PDMS type wherein the methyl groups are partly replaced by alkylene polyoxide groups (of ethylene polyoxide or propylene polyoxide type or an ethylene polyoxide and propylene polyoxide mixture polymer) or pyrrolidone groups such as PDMS/hydroxy-alkylene oxypropyl-methyl siloxane derivatives or alkyl methyl siloxane/hydroxy-alkylene oxypropyl-methyl siloxane derivatives.

These copolyols obtained by hydrosilylation reaction have reactive terminal hydroxyl groups. They can therefore be used to obtain ester groups, for example by reaction of a fatty acid, or alkanolamide groups, or glycoside groups.

Silicone polymers comprising alkyl side groups (hydrophobic) directly linked to the silicon atom can also be modified by reaction with fluoro alcohol type molecules (hydrophilic) so as to form amphiphilic compounds.

The surfactant properties are adjusted with the hydrophilic group/hydrophobic group ratio.

PDMS copolymers can also be made amphiphilic by anionic groups such as phosphate, carboxylate, sulfate or sulfosuccinate groups. These polymers are generally obtained by reaction of acids on the terminal hydroxide functions of polysiloxane alkylene polyoxide side chains.

PDMS copolymers can also be made amphiphilic by cationic groups such as quaternary ammonium groups, quaternized alkylamido amine groups, quaternized alkyl alkoxy amine groups or a quaternized imidazoline amine. It is possible to use, for example, the PDMS/benzyl trimethyl ammonium methylsiloxane chloride copolymer or the halogeno N-alkyl-N,Ndimethyl-(3-siloxanylpropyl)ammonium derivatives.

PDMS copolymers can also be made amphiphilic by betaine type groups such as a carboxybetaine, an alkylamido betaine, a phosphobetaine or a sulfobetaine. In this case, the copolymers comprise a hydrophobic siloxane chain and, for example, a hydrophilic organobetaine part of general formula:

(Me₃SiO)(SiMe₂O)ₐ(SiMeRO)SiMe₃

with R═(CH₂)₃+NMe₂(CH₂)_{b}COO⁻; a=0, 10; b=1, 2.

The amphiphilic compounds comprising a neutral, anionic, cationic or zwitterionic hydrophilic part can also have a halogenated or perhalogenated hydrophobic part (defined as having a high affinity with the non-water miscible solvent). These halogenated amphiphilic compounds, oligomers or polymers, can also be used for water/organic solvent or water/halogenated or perhalogenated solvent or water/silicone solvent mixtures.

Halogenated amphiphilic compounds such as, for example, fluorine compounds can be ionic or non-ionic. The following can be mentioned in particular:

non-ionic amphiphilic halogenated or perhalogenated compounds such as the compounds of general formula Rf(CH₂)(OC₂H₄)ₙOH, wherein Rf is a partly hydrogenated perfluorocarbon or fluorocarbon chain, where n is an integer at least equal to 1, the fluorinated non-ionic surfactant agents of polyoxyethylene-fluoroalkylether type,

the ionizable amphiphilic compounds for forming anionic compounds, such as perfluorocarboxylic acids and their salts, or perfluorosulfonic acids and their salts, perfluorophosphate compounds, mono and dicarboxylic acids derived from perfluoro polyethers and their salts, mono and disulfonic acids derived from perfluoro polyethers and their salts, perfluoro polyether phosphate amphiphilic compounds and perfluoro polyether diphosphate amphiphilic compounds,

perfluorinated cationic or anionic amphiphilic halogenated compounds or those derived from perfluoro polyethers having 1, 2 or 3 hydrophobic side chains, ethoxylated fluoroalcohols, fluorinated sulfonamides or fluorinated carboxamides.

The amphiphilic compound is added to the water/solvent liquid solution in a proportion ranging between 0.1 and 10 wt. %, preferably between 0.1 and 5 wt. %, in relation to the phase non-miscible in the aqueous phase, i.e. the solvent.

What is referred to as a “hydrate promoter” compound is, in the sense of the present invention, any chemical compound having the property of lowering the hydrate formation pressure and/or of modifying the hydrate formation kinetics.

The hydrate promoter compounds according to the invention can be selected from among tetrahydrofurane (THF) and the compounds of general formula (I):

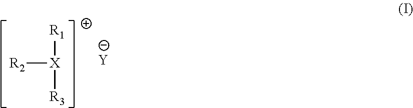

with X═S, N—R₄ or P—R₄,
Y is an anion selected from the group consisting of a hydroxyl, a sulfate or a halogen. The halogen can be selected from the group consisting of bromine, fluorine, chlorine and iodine,
R₁, R₂, R₃, R₄ are identical or different, and selected from the group consisting of linear or branched C1-C5 alkyl radicals. Linear or branched alkyl radicals with 1 to 5 carbon atoms are understood to be, in particular, methyl, ethyl, propyl, isopropyl, butyl, isobutyl, sec-butyl, tert-butyl and pentyl radicals.

Preferably, in order to improve the performances of the hydrate promoters, an association of hydrate promoters containing tetrahydrofurane (THE) and at least one compound of general formula (I) is used.

Among the promoters of formula (I), ammonium alkyls and phosphonium alkyls are preferably used.

Preferably, the promoter of formula (I) is selected from the group consisting of tetraethylammonium bromide (TEAB), tetrapropylammonium bromide (TPAB), tetrabutylammonium hydrogen sulfate (TBAHS), tetrabutylammonium chloride hydrate (TBACl), tetrabutylammonium iodide (TBAl), tetrabutylammonium hydroxide (TBAOH), tetrabutylammonium fluoride hydrate (TBAF), tetrabutylammonium bromide (TBAB), tetrabutylphosphonium bromide (TBPB) and tetra iso amyl ammonium bromide (TiAAB).

In particular, among the compounds of formula (I), a compound can be selected from the subgroup of promoters of formula (II) as follows, wherein:

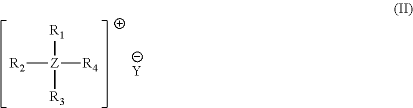

Z=N or P,
Y is an anion selected from the group consisting of a hydroxyl, a sulfate or a halogen. The halogen can be selected from the group consisting of bromine, fluorine, chlorine and iodine,
R₁═R₂═R₃═R₄=butyl.

Preferably, the promoter of formula (II) is selected from the group consisting of tetrabutylammonium bromide (TBAB), tetrabutylammonium fluoride hydrate (TBAF) and tetrabutylphosphonium bromide (TBPB).

The liquid solution according to the invention can comprise a proportion of hydrate promoter ranging between 1 and 30 mole %, preferably between 1 and 20 mole % in relation to the aqueous phase in the liquid solution.

In cases where an association of at least two hydrate promoters is used, the tetrahydrofurane is added to the liquid solution in a proportion ranging between 1 and 15 mole % in relation to the aqueous phase, preferably between 3 and 12 mole % in relation to the aqueous phase and more preferably between 6 and 9 mole % in relation to the aqueous phase of the liquid solution, and the promoter of formula (I) or the promoter of formula (II) is added to the liquid solution in a proportion ranging between 1 and 20 mass % in relation to the aqueous phase, preferably between 5 and 15 mass % in relation to the aqueous phase and more preferably between 7 and 12 mass % in relation to the aqueous phase of the liquid solution.

The example hereafter allows to illustrate the stage of dividing the hydrate slurry into two fractions.

A suspension containing 20% hydrate particles is in a reactor maintained at a pressure of the order of 3 bars and at a temperature of 3° C. under stirring. The suspension has a homogeneous character. When stirring is stopped after 10 seconds the particles have settled in the reactor bottom and the non-miscible solvent is clear because free of hydrate particles.

1) A method of capturing acid compounds contained in a gas, wherein the following stages are carried out:
a) contacting the gas with a liquid solution comprising a mixture of an aqueous phase and of a non-water miscible phase so as to produce a solution comprising acid compound hydrates and an acid compound depleted gas,
b) dividing the solution comprising acid compound hydrates into a hydrate-rich fraction and a fraction rich in non-water miscible phase,
c) separating the hydrate-rich fraction from the fraction rich in non-water miscible phase,
d) heating the hydrate-rich fraction so as to release gaseous acid compounds by dissociating the hydrates and to produce a water-rich fraction,
e) mixing the fraction rich in non-miscible phase obtained in stage c) with the water-rich fraction produced in stage d) so as to produce the liquid solution used in stage a).

2) A method as claimed in claim 1, wherein stages b) and c) are carried out in a separation device and stage d) is carried out in a reactor.

3) A method as claimed in claim 1, wherein stages b), c) and d) are carried out successively in the same device.

4) A method as claimed in claim 1, wherein:
stage a) is carried out at a pressure ranging between 0.1 and 20 bars, and at a temperature ranging between −5° C. and 20° C.,
stages b) and c) are carried out at a pressure ranging between 0.1 and 20 bars,
stage d) is carried out at a pressure ranging between 5 and 70 bars, and at a temperature ranging between −5° C. and 30° C.,
stage e) is carried out at a pressure ranging between 0.1 and 20 bars.

5) A method as claimed in claim 1, wherein:
stage a) is carried out at a pressure ranging between 0.1 and 20 bars, and at a temperature ranging between −5° C. and 20° C.,
stages b) and c) are carried out at a pressure ranging between 5 and 70 bars,
stage d) is carried out at a pressure ranging between 5 and 70 bars, and at a temperature ranging between −5° C. and 30° C.,
stage e) is carried out at a pressure ranging between 0.1 and 20 bars.

6) A method as claimed in claim 1 wherein, prior to stage a), a stage of cooling the liquid solution is carried out.

7) A method as claimed in claim 1, wherein the non-water miscible phase is selected from the group consisting of hydrocarbon solvents, silicone type solvents, halogenated or perhalogenated solvents, and mixtures thereof.

8) A method as claimed in claim 1, wherein the liquid solution furthermore comprises at least one non-ionic, anionic, cationic or zwitterionic amphiphilic compound having at least the anti-agglomeration property of hydrates.

9) A method as claimed in claim 1, wherein the liquid solution also comprises at least one hydrate promoter compound selected from among tetrahydrofurane and the compounds of general formula (I): 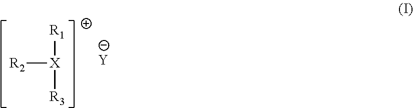
with X═S, N—R₄ or P—R₄,
Y is an anion selected from the group consisting of a hydroxyl, a sulfate or a halogen,
R₁, R₂, R₃, R₄ are identical or different, and selected from the group consisting of linear or branched C1-C5 alkyl radicals.

10) A method as claimed in claim 9, wherein the liquid solution comprises tetrahydrofurane and a hydrate promoter compound of general formula (I).

11) A method as claimed in claim 1, wherein the gas is a combustion fume and the acid compounds contain CO₂.

12) A method as claimed in claim 1, wherein the gas is selected from among a natural gas, a Claus tail gas, a syngas, a conversion gas, a biomass fermentation gas, and the acid compounds comprise at least one of the following elements: CO₂ and H₂S.
